(19) United States
(12) Patent Application Publication
(10) Pub. No.: US 2019/0045583 A1
(43) Pub. Date: Feb. 7, 2019

(54) MULTICONNECTIVITY CLUSTER

(71) Applicant: NOKIA SOLUTIONS AND NETWORKS OY, Espoo (FI)

(72) Inventors: Vinh Van Phan, Oulu (FI); Ling Yu, Kauniainen (FI); Peter Rost, Heidelberg (DE)

(21) Appl. No.: 16/074,751

(22) PCT Filed: Feb. 3, 2016
(86) PCT No.: PCT/EP2016/052247

§ 371 Date: Aug. 1, 2018

(51) Int. Cl. H04W 92/20; H04W 16/10; H04J 11/00; H04B 7/02

(52) U.S. Cl. CPC H04W 92/20; H04B 7/02; H04J 11/0093; H04W 16/10

(57) ABSTRACT

A cluster of access points is determined for a terminal device for multi-connectivity, an access points in the cluster belonging either to a first subset or to a second subset; an access point in the first subset being configured by a first configuration configuring the access point to receive and forward one or more scheduled transport blocks from the terminal device and/or to the terminal device; and an access point in the second subset being configured by a second configuration configuring the access point to decide whether or not to receive and forward one or more scheduled transport blocks from the terminal device and/or to the terminal device and act accordingly.

### TECHNICAL FIELD

The invention relates to wireless communications in a cellular communication system and, in particular, to multi-connectivity.

### BACKGROUND

Modern fourth generation cellular systems provide terminal devices with multi-connectivity where a terminal device may be connected to a radio access network via a plurality of access nodes concurrently, for example when the terminal device receives services in a small-cell ultra-dense network.

### BRIEF DESCRIPTION

According to an aspect, there is provided the subject matter of the independent claims. Some embodiments are defined in the dependent claims.

One or more examples of implementations are set forth in more detail in the accompanying drawings and the description below. Other features will be apparent from the description and drawings, and from the claims.

### BRIEF DESCRIPTION OF DRAWINGS

In the following embodiments will be described in greater detail with reference to the attached drawings, in which

FIG. 1 illustrates an exemplified wireless communication system;

FIGS. 2 to 6 illustrate exemplified processes;

FIGS. 7 to 9 illustrate exemplified information exchanges and related processes;

FIG. 10 illustrates an example of a frame structure;

FIGS. 11 and 12 illustrate further exemplified information exchanges and related processes; and

FIGS. 13 and 14 are schematic block diagrams.

### DETAILED DESCRIPTION OF SOME EMBODIMENTS

The following embodiments are exemplifying. Although the specification may refer to “an”, “one”, or “some” embodiment(s) and/or example(s) in several locations of the text, this does not necessarily mean that each reference is made to the same embodiment(s) or example(s), or that a particular feature only applies to a single embodiment and/or example. Single features of different embodiments and/or examples may also be combined to provide other embodiments and/or examples.

Embodiments and examples described herein may be implemented in a wireless system, such as in at least one of the following: Universal Mobile Telecommunication System (UMTS, 3G) based on basic wideband-code division multiple access (W-CDMA), high-speed packet access (HSPA), Long Term Evolution (LTE), LTE-Advanced, 5G system, beyond 5G, and/or wireless local area networks (WLAN), such as Wi-Fi. The embodiments are not, however, restricted to the system given as an example but a person skilled in the art may apply the solution to other communication systems provided with necessary properties. One example of a suitable communications system is the 5G system, as listed above.

5G is likely to use multiple-input-multiple-output (MIMO) multi-antenna transmission techniques, many more base stations or access nodes than the current network deployments of LTE (a so-called small cell concept), including macro sites operating in co-operation with smaller local area access nodes, such as local ultra-dense deployment of small cells, and perhaps also employing a variety of radio technologies for better coverage and enhanced data rates. 5G will likely be comprised of more than one radio access technology (RAT), each optimized for certain use cases and/or spectrum. 5G mobile communications will have a wider range of use cases and related applications including video streaming, augmented reality, different ways of data sharing and various forms of machine type applications, including vehicular safety, different sensors and real-time control. 5G is expected to have multiple radio interfaces, namely interfaces for frequency ranges below 6 GHz, cmWave frequency ranges ranging from 3 GHz to 30 GHz, mmWave frequency ranges ranging from 30 GHz to 100 GHz, and/or for even higher frequencies, and also being integrated and/or interoperate with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or cloud data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labor between core network operations and base station operations, and terminal device operations may differ from that of the LTE or even be non-existent. Some other technology advancements probably to be used are Software-Defined Networking (SDN), Big Data, and all-IP, which may change the way networks are being constructed and managed. For example, one or more of the below described network node functionalities may be migrated to any corresponding abstraction or apparatus or device. Therefore, all words and expressions should be interpreted broadly and they are intended to illustrate, not to restrict, the embodiment.

Below different examples are described assuming a small-cell ultra-dense network, without restricting the embodiments thereto. It is a straightforward process for one skilled in the art to apply the teachings to other networks configurable to support multi-connectivity.

A multi-connectivity scheme that utilizes, for example, connection-oriented broadcast based uplink and unicast based downlink transmissions may use the ultra-dense network, or a corresponding network or a cell arrangement. Such a multi-connectivity scheme may be based on having a dynamic coordinated and cooperative multi-connectivity cluster for a terminal device, the cluster comprising base stations in proximity of the terminal device, some of the base stations receiving and forwarding all transmissions, and some of the base stations deciding whether or not to receive and forward a transmission. A multi-connectivity controller node, such as a base station serving the terminal device, determines the base stations forming the cluster, and how each base station will take part in the transmission, and configures the base stations and the terminal device correspondingly, as will be described in more detail below. The multi-connectivity scheme may be used for network access to services that have challenging requirements, such as ultra-low latency and/or ultra-high reliability.

Although the examples below describe the multi-connectivity scheme for the uplink direction, it should be appreciated that it is a straightforward process for one skilled in the art to apply the same or similar principles for a single frequency network (SFN)—based multi-transmitter diversity multi-connectivity scheme for the downlink direction. Further, it should be appreciated that the multi-connectivity scheme may be extended to be used with any combination of broadcast and unicast for the uplink and downlink directions that provides multi-connectivity at least to one direction, and applied for connectionless packet access services as well.

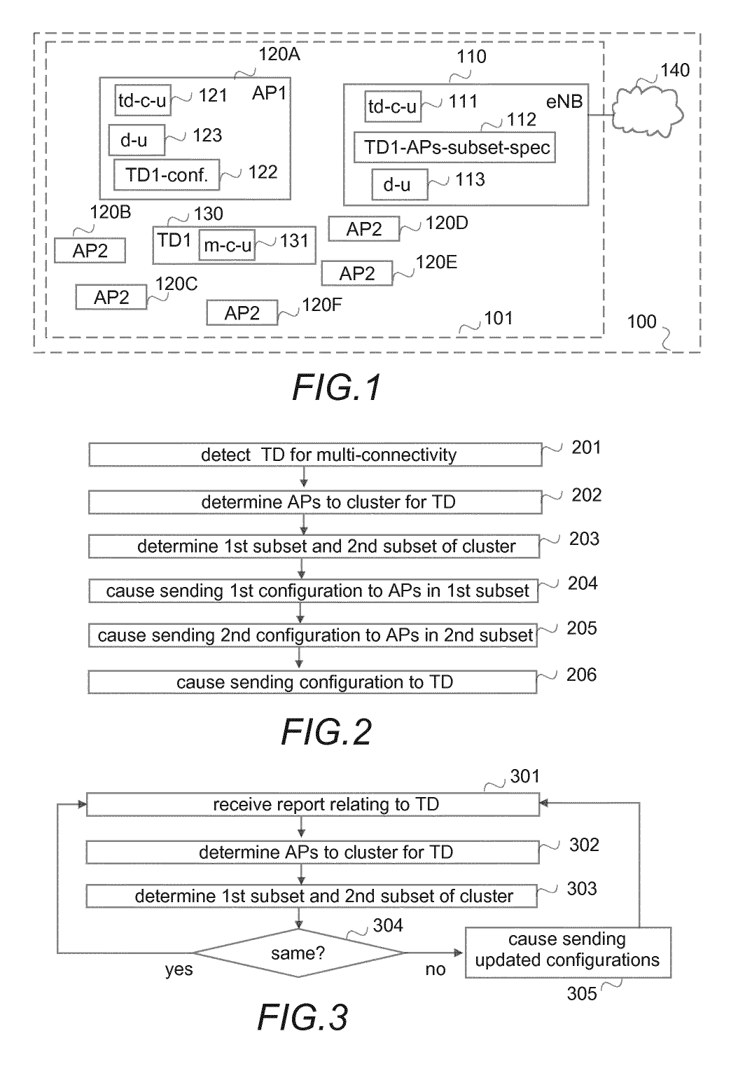

An extremely general architecture of an exemplifying system 100 to which embodiments of the invention may be applied is illustrated in FIG. 1. FIG. 1 is a simplified system architecture only showing some elements and functional entities, all being logical units whose implementation may differ from what is shown. It is apparent to a person skilled in the art that the system may comprise any number of the illustrated elements and functional entities.

Referring to FIG. 1, a cellular communication system 100, formed by one or more cellular radio communication networks, such as the Long Term Evolution (LTE), the LTE-Advanced (LTE-A) of the 3rd Generation Partnership Project (3GPP), or the predicted future 5G solutions, are typically composed of one or more network nodes that may be of different type. An example of such network nodes is a network node providing a wide area, medium range or local area coverage for terminal devices, for example for the terminal devices to obtain wireless access to other networks 140 such as the Internet, either directly or via a core network (not illustrated in FIG. 1). As is shown in the example of FIG. 1, there may be network scenarios where network nodes, called local area base stations 120A-120F, such as small cell access points (AP) providing a micro cell, a femto cell, or a pico cell, for example, are disposed within the coverage area 101 of a macro cell provided by a network node 110, called a macro cell base station, such as an evolved NodeB (eNB). A certain base station may be categorized as an access point on the basis of the transmission power, for example. The local area base stations 120A-120F may be a private base station, a home node B (hNB), a private access point, a closed access base station, a terminal device, a mobile phone, or the like. In general a base station may be any network node (device, apparatus) capable of providing coverage and controlling radio communication within its own cell.

Provision of many access points 120A-120F to an area may generate an ultra-dense network (UDN) to the area. As there may be many access points 120A-120F in the ultra-dense network, one access point with low transmission power may often serve only a single or few terminals at a time. In such dense local area deployment, the density of small cell access points 120A-120F may be even higher than that of terminal devices (TD1) 130. Further, a terminal device 130 in the ultra-dense network may be in overlapping coverage areas of multiple access points. In multi-connectivity a terminal device may connect to two or more base stations (APs, eNB), one of the base stations operating as a multi-connectivity controller node. The multi-connectivity controller node may be a multi-connectivity anchor for the terminal device, or the multi-connectivity anchor is another network node. Further, the multi-connectivity anchor may be the same node as the serving access point for downlink or a different node.

In the illustrated example base stations 110, 120A-120F are configured to operate as the multi-connectivity controller node and to support multi-connectivity with connection-oriented broadcast-based uplink and unicast-based downlink transmissions. For that purpose the local area base stations 120A-120F and the macro cell base station 110 each comprises a terminal device-specific configuration unit (td-c-u) 111, 121, whose functionality will be described in more detail below as part of a multi-connectivity controller node functionality, and memory 112, 122. However, if an access point, i.e. a local area base station or the macro cell base station, is not configured to operate as the multi-connectivity controller node, it may not comprise the terminal device-specific configuration unit. Further, the macro cell base station 110 and the local area base stations 120A-120F each is configured to act as a cluster member and comprises for that purpose a decision unit (d-u) 113, 123 whose functionality will be described in more detail below as part of an access point (access node) functionality. (In FIG. 1, the units are illustrated only in one access point, even though each access point comprises them).

However, it should be appreciated that there may be macro cell base stations and/or local area base stations that do not comprise the decision unit. In the illustrated example of FIG. 1, the network node that is the multi-connectivity controller node for the terminal device 130 is the macro cell base station (eNB) 110, and the local area base stations 120A-120F depict access points (i.e. a node that is not the multi-connectivity controller node), and therefore the memory 112 of the macro cell base station 110 comprises for the terminal device (TD1) 130 access points that are associated with a certain subset, which will be described in more detail below. However, it should be appreciated that a local area base station may act as a multi-connectivity controller node as well, and the macro cell base station as an access point. In other words, the multi-connectivity controller node functionality may be part of a macro cell base station, a local area base station, an access point, a node managing many access points, or a corresponding single instance. Further a node configured with the multi-connectivity controller node functionality may be part of a cloud radio access network (C-RAN) deployment, and/or co-locate with existing infrastructure, such as a points of presence (PoP) network or even a core network (CN).

The terminal device (TD1) 130 refers to a portable computing device (equipment, apparatus), and it may also be referred to as a user device, a user terminal or a mobile terminal or a machine-type-communication (MTC) device, also called Machine-to-Machine device and peer-to-peer device. Such computing devices (apparatuses) include wireless mobile communication devices operating with or without a subscriber identification module (SIM) in hardware or in soft-ware, including, but not limited to, the following types of devices: mobile phone, smart-phone, personal digital assistant (PDA), handset, laptop and/or touch screen computer, e-reading device, tablet, game console, notebook, multimedia device, sensor, actuator, video camera, car, refrigerator, other domestic appliances, telemetry appliances, and telemonitoring appliances. In the illustrated example the terminal device 130 is configured to support multi-connectivity with connection-oriented broadcast-based uplink and unicast-based downlink transmissions. For that purpose the terminal device 130 comprises a multi-connectivity unit 131. Examples of different functionalities of the multi-connectivity unit will be described in more detail below as part of the terminal device functionality.

FIG. 2 is a flow chart illustrating an exemplified basic functionality of a network node configured to operate as a multi-connectivity controller node, or more precisely, the terminal device-specific configuration unit in the network node.

Referring to FIG. 2, when a terminal device, which is configured to support multi-connectivity, fulfilling criteria for multi-connectivity and for which the network node will be the multi-connectivity controller node, is detected in block 201, a cluster of access points, i.e. an access point cluster, or shortly cluster, to the terminal device is determined in block 202. The criteria that may trigger the use of multi-connectivity may be defined freely. One criterion is naturally that the terminal device is in an area in which two or more access points have overlapping coverage areas. Further, latency-reliability requirements and/or traffic characteristics of on-going services may be used as part of the criteria. The cluster comprises local small-cell access points that are currently in proximity of the terminal device. The determination may be based on one or more of the following information:
1) Received reports, such as discovery reports, from the terminal device, the terminal device reporting discovered small cells. A discovery report may include received signal power of discovery beacons or reference signal, channel quality measurements or estimates, relative or exact location information, detected cell or access point identifiers, amongst other things.
2) Received reports, such as discovery reports, from small cell access points, a small cell access point reporting discovered terminal devices of interest. The network node serving the terminal device may configure the terminal device to send a dedicated beacon or a reference signal periodically within the service area of the network node, and the network node may configure access points under its coordination and control inside said service area to monitor and receive the dedicated beacon or the reference signal to discover the presence of the terminal device in the proximity. In other words, the network node, that is to be the multi-connectivity controller node, may proactively configure the access points under its control and coordination to discover the terminal device when it comes to the proximity.
3) Knowing at least one small cell access point serving the terminal device, and using its neighbor cell information. By serving it is meant that the small cell access point is aware that the terminal device is connected to it. For example, the small cell access point may provide a radio resource control (RRC) connection or control plane radio bearer service to the terminal device. When the small cell access point serving the terminal device will be the multi-connectivity controller node, there will be no additional signaling overhead to obtain the neighbor cell information.
4) A location and a radio range of the access point in the cluster/locations and radio access ranges of access points in the cluster.

Once the cluster of access points is determined, it is determined in block 203 which ones of the access points will belong to a first subset and will have a first configuration and which ones to a second subset and will have a second configuration. The access points in the first subset will be configured to receive any scheduled transmission or transport block from the terminal device and forward it to a multi-connectivity anchor. Therefore the first subset has to comprise at least one access point. The access points in the second subset are configured to determine transport block—specifically whether or not to take part (be involved) in receiving and forwarding the transport block, as will be described in more detail below. The selection of whether an access point is assigned to the first subset or to the second subset may depend on the number of access points in the cluster, and/or a load in the access point, and/or the load in the access point compared to loads in other access points in the cluster, and/or a radio link quality between the access point and the terminal device. The radio link quality may be received in a link quality measurement report from the terminal device, for example.

Once the access points in the determined cluster are divided into the first subset and the second subset, the access points and the terminal device are configured correspondingly. More precisely, sending of the first configuration to access points in the first subset is caused in block 204, sending of the second configuration to access points in the second subset is caused in block 205 and sending configuration to the terminal device is caused in block 206.

The configuration sent to access points in the first subset may include information that the access point belongs to the first subset of the terminal device, and information needed for monitoring, receiving and forwarding. For example, a format to be used may be sent and configured to the access points as well. The format may be PHY TB (Physical layer Transport Block) or MAC PDU (Medium Access Control layer Protocol Data Unit) or MAC SDU (Medium Access Control layer Service Data Unit). Examples of other possible information sent in the configuration will be described in more detail below.

The configuration sent to access points in the second subset may include the information, or corresponding indication, that the access point belongs to the second subset of the terminal device, and possibly other information. For example, in an implementation the same decision criteria to determine whether or not to take part will be used, in which case only parameter values for the decision criteria may be sent, or nothing relating to the decision will be sent. In another implementation, also the decision criteria that is to be used to decide whether or not to take part, is also determined case by case, and send as configuration information. For example, the configuration may comprise “prioritize your own” as the decision criteria, and then be updated to be “use probability” as the decision criteria. The different decision criteria will be described in more detail below. Naturally, the configuration sent to access points in the second subset include all the information needed for the monitoring, receiving and forwarding that is sent to access points in the first subset, to enable the access point to perform the monitoring, receiving and forwarding.

The configuration sent to the terminal device may be only information on one access point in the first subset, the one access point serving the terminal device both in uplink and in downlink for control plane, as least. In other words, the terminal device may use the uplink broadcast without knowing other access points in the cluster. However, it should be appreciated that information on all access points in the cluster, or other cluster related information, or at least information on access points belonging to the first subset, may be in the configuration sent to the terminal device. Further, since the uplink is broadcast, there is no need to establish a radio connection between the terminal device and each access point involved in the multi-connectivity. This reduces signaling overhead and latency for uplink transmissions compared to prior art multi-connectivity solutions in which the terminal device needs to establish a radio connection with each access point involved in the multi-connectivity of the terminal device. Further, the configuration sent to the terminal device may contain information/settings relating to scheduling and/or resources and/or format to be used, as will be described in more detail below. Yet another example of configuration sent to the terminal device, and to an access point serving the terminal device in downlink, if different from the multi-connectivity controller node, is configuration to apply HARQ (hybrid automatic repeat request) with ACK/NACK from the access point serving the terminal device (from the multi-connectivity controller node, if they are the same), or simple HARQ with automatic replication or duplication of the same packet by N times.

The multi-connectivity controller node receives different reports, and therefore, once a report is received the cluster is updated, if needed, correspondingly.

FIG. 3 is a flow chart illustrating an exemplified basic functionality of a network node configured to operate as a multi-connectivity controller node, or more precisely, the terminal device-specific configuration unit in the network node, after a cluster has been first time defined.

Referring to FIG. 3, when a report is received in block 301, an updated cluster of access points to the terminal device is determined in block 302. It may be that the terminal device has moved, which may cause changes to the access points in the cluster. Then it is determined in block 303 which ones of the access points will belong to a first subset and which to a second subset. This time also implicit indications on radio link qualities may be taken account, such as received and forwarded uplink data access point—specifically, i.e. by access points in the first subset and access points in the second subset. For example, if it is detected that in uplink data forwarded from AP1 in the current first subset continuous errors has occurred while AP2 in the current second subset provides better link quality with less errors, after this round AP1 may be in the second subset and AP2 in the first subset. Once the new subsets are determined, it is checked in block 304, whether or not the subsets are the same as the current ones. If they are, the process returns to block 301 to receive a report. If the subsets are not the same (block 304), updated configurations are caused to be sent in block 305. Depending on an implementation, updated configurations are sent only to those access points whose configuration has been changed, or to all access points of the cluster.

Further, an updated configuration may be sent to the terminal device, especially if the one access point serving the terminal device both in uplink and in downlink for control plane in the first subset is changed to be in the second subset, or the configuration information initially contained information on other access points in the first subset as well, or information on all access points determined to the cluster.

As can be seen from the above, the cluster is a dynamic collection of network nodes (base stations) that will be adapted according to a mobility of the terminal device (terminal device centric mobility).

Below it is assumed, for the sake of clarity, that the multi-connectivity controller node is also the multi-connectivity anchor node. The multi-connectivity controller node may belong to the cluster, either in the first subset or in the second subset, or it may not belong to the cluster. However, that does not affect to the described examples.

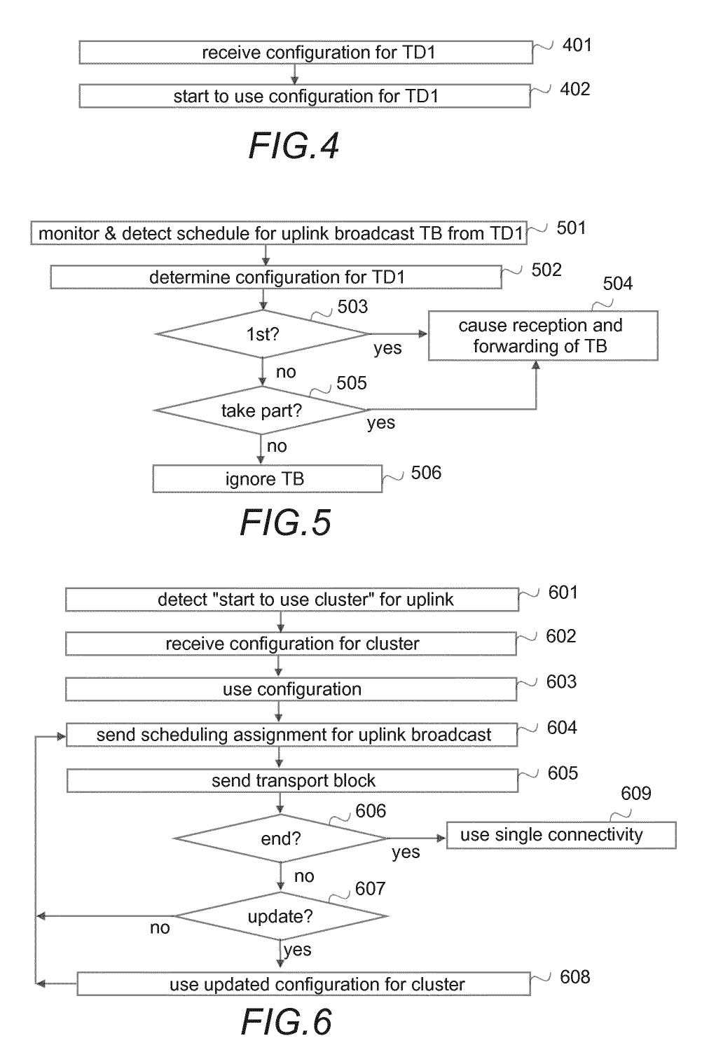

FIGS. 4 and 5 are flow charts illustrating an exemplified basic functionality of a network node configured to be the access point providing the multi-connectivity, or more precisely, the functionality of the decision unit.

Referring to FIG. 4, once a configuration (initial or update) for a terminal device is received in block 401 from the multi-connectivity controller node, the access point starts in block 402 to use the configuration received in block 401, as is described in more detail with FIG. 5.

Referring to FIG. 5, when scheduling information, such as a scheduling assignment, for an uplink broadcast transport block (TB) from a terminal device that the access point is configured to monitor is detected in block 501, a configuration to be used for transmissions from the terminal device is determined in step 502. This determination of the configuration is performed because the access point may belong to clusters of two or more different terminal devices, and the access point may have the configuration of the first subset to some terminal devices and the configuration of the second subset to other terminal devices. Further, the configuration of the second subset, such as decisions criteria, may be different for different terminal devices.

If the configuration is the first configuration (block 503), i.e. the configuration of the first subset, reception and forwarding the transport block towards the multi-connectivity anchor node is caused in block 504.

If the configuration is not the first configuration (block 503), the configuration is the second configuration, i.e. the configuration of the second subset, it is decided (block 505) whether or not to take part in the forwarding of the transport block. There are several alternative criteria that may be used in the decision. The criteria may depend on the available capacity of the access point and/or its momentary occupancy status, i.e. the access point not being able to take part in receiving and forwarding a transport block from the terminal device in a slot since the access point is busy to serve other terminal devices in the same slot.

For example, the access point may decide to take part in the receiving and forwarding of the transport block if no downlink transmissions for terminal devices having the first configuration, or a terminal device served by the access point in a single-connectivity mode, is scheduled in the transmission time interval. In other words, the access point is configured to prioritize to serve its “own” terminal devices.

Other examples include that the access point may use the number of received scheduling assignments from/to all those terminal devices for which the access point has configurations, i.e. to whose clusters the access point belongs, and/or take into account the amount of resources scheduled in the received scheduling assignments from/to those terminal devices.

Still another example includes deciding whether or not to take part based on results obtained on interference monitoring, as part of the inter-cell interference coordination (ICIC). For example, if the interference level in the access point is experienced to be so high that it is likely that the access point will not receive a transmission from the terminal device correctly, the access point will not take part.

Another example includes that the decision whether or not to take part may depend on probability. In other words, the access point may decide to take part (serve) with a probability of P and not to take part with a probability of 1-P. The multi-connectivity controller node may add the value of P to the configuration the multi-connectivity controller node send to access points in the second subset. The value of P may depend on how many access point there is in the current cluster, and how many of them is in the first subset and how many in the second subset. The value may be provided implicitly or explicitly. For example, if there are four access points in the current cluster so that two of them are in the first subset and two of them in the second subset, P may be set to be 0.5 by the multi-connectivity controller node, or if the first subset comprises one access point, and the remaining three access points are in the second subset, P may be set to be 0.75 by the multi-connectivity controller node. Alternatively, the multi-connectivity controller node may forward the cluster information to the access point, and possibly one or more rules by means of which the access point may determine the value for P. The access point may take into account additional information, such as current load in the access point.

Still a further example uses a probability offset (Poffset). The access point may receive a value for the probability offset along with information on resource allocation dedicated to the terminal device to send at least the scheduling assignment. In other words, each access point belonging to the second subset of the cluster determined for the terminal device, receives the same value for the probability offset. The access point may then make the decision to take part on the probability P=Poffset+(1−Poffset)*Q, wherein Q is a variable between zero and one, determined by the access point locally, and not to take part with a probability of 1−P. Q may be determined by the access point, on a fly, based on local load and/or, error rate of transmissions, scheduled resources indicated in a received scheduling assistant, etc. for example. By means of Q it is possible to make optimized decision using simple and effective enough mathematics. A further advantage is that this ensures that the second subset comprises in praxis always some access points that will take part in the receiving and forwarding uplink transport blocks. This in turn makes it to possible to have small number of access points in the first subset, and yet to provide reliable enough functionality. The probability offset, or the probability, may be any value between zero and one, for example an inverse of the amount of access points in the second subset. The solutions in which the decision uses the probability may be called soft-decision solutions.

If the decision is to take part (block 505) in receiving and forwarding the transport block, reception and transmission of the transport block is caused in block 504. If the decision is not to take part (block 505), the transport block is ignored in block 506.

It should be appreciated that although in the above example of FIG. 5, the decision whether or not to take part is performed transport block—specifically, the decision may be made for also for two or more transport blocks, for example scheduling assignment—specifically.

FIG. 6 is a flow chart illustrating an exemplified basic functionality of a terminal device configured to support the multi-connectivity, or more precisely, the functionality of the multi-connectivity unit. In the FIG. 6 it is assumed that the terminal device has both a scheduled unicast uplink and a scheduled unicast downlink, and that the configuration of the uplink is changed, whereas the downlink configuration is not affected, without restricting the example to such a solution. It is a straightforward solution to implement the example to downlink multi-connectivity.

In the illustrated example, it is first detected, in block 601, that the multi-connectivity is triggered. In other words, the cluster will be used for the connection-oriented uplink broadcast. The terminal device, or the multi-connectivity unit, may be configured to detect in broadcast received from one or more access point an implicit or an explicit indication that indicates support for the connection-oriented uplink broadcast from terminal devices.

The terminal device, or the multi-connectivity unit, may be configured to start to use the multi-connectivity provided by the connection-oriented uplink broadcast in response to receiving such an indication from one access point, or from a predetermined number of access points, while continuing use of the scheduled unicast downlink. The currently serving base station (macro cell or small cell), or another network node in the radio access network may configure, i.e. instruct, the terminal device, or the multi-connectivity unit, to start, for example by using explicit short command or more extensive control signaling to convey necessary information. Reception of such a command or control signaling causes that the start is detected (block 601). The short command may be at simplest a one bit command to instruct the terminal device to activate (re-activate) or de-active the multi-connectivity mode. The control signaling may be common control signaling, or dedicated control signaling, or a combination of the common and dedicated control signaling.

After block 601, or simultaneously with block 601, or as part of extensive control signaling, configuration to be used with the broadband uplink for the specific connection, is received in block 602. The configuration may be at the simplest information on one access point in the first subset. For example, other configuration for the multi-connectivity may be preconfigured to the terminal device. However, the received configuration may comprise further information relating to resources and/or scheduling and/or formats, etc., as is described in more detail with FIG. 2 and will be described below.

Once the configuration is received, it will be used (block 603). Part of using the configuration is to send a scheduling assignment in block 604 to indicate a forthcoming uplink broadcast of a transport block, and then to send in block 605 in block the transport block as scheduled. Different scheduling possibilities are described in more detail below.

Naturally it is monitored, whether a “stop uplink broadcast” is detected in block 606, or an updated configuration is received in block 607. If none of them is received, the process continues to block 604 to send the next scheduling assignment.

If an updated configuration is received (block 607), the configuration is updated correspondingly and the updated configuration will be used (block) 608, and the process proceeds to block 604 to send the next scheduling assignment.

If the “stop” is received (block 606), the single-connectivity will be used in block 609. In other words, the terminal device will be configured to return to use scheduled unicast uplink for the connection-oriented data exchange. Naturally the terminal device will continue to use the unicast downlink.

The configurable resource allocation modes for connection-oriented broadcast uplink include a first mode in which the multi-connectivity controller node allocates to the terminal device dedicated resources for sending at least a scheduling assignment for one or more next broadcast uplink transmissions, and a second mode in which the terminal device is configured, by the multi-connectivity controller node, to select or allocate resources from resource pools that are preconfigured for proximity broadcast based uplink transmissions, including connectionless broadcast uplink transmissions.

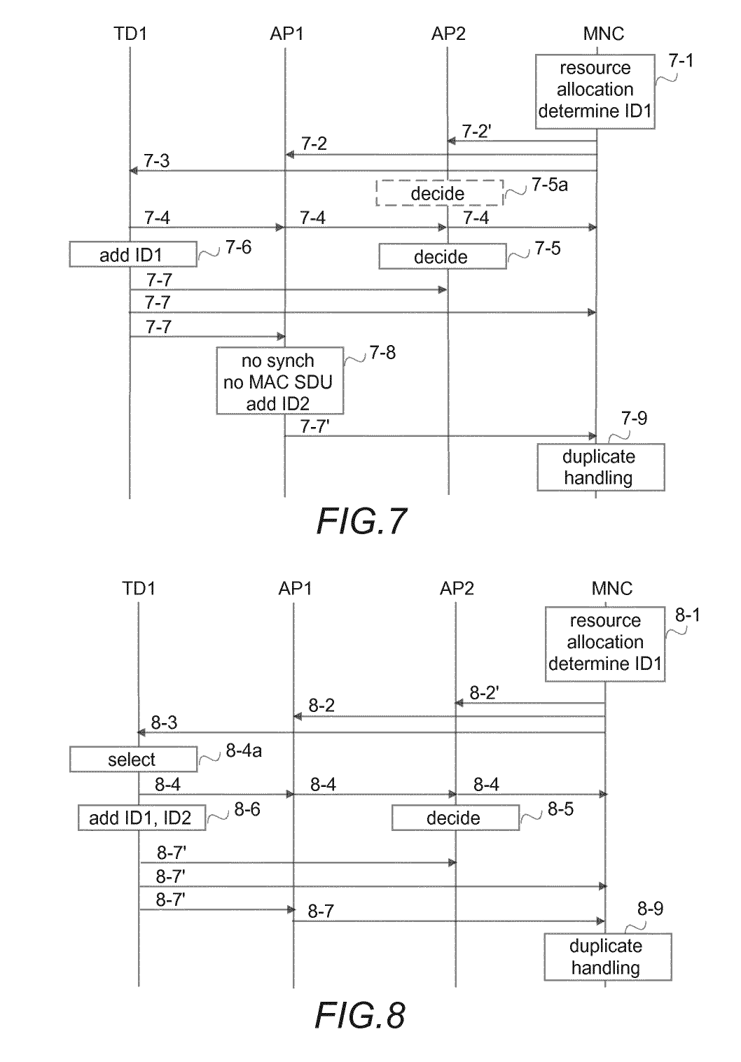

FIGS. 7 to 9 illustrate different exemplified implementation possibilities of the first mode. In the examples AP1 illustrates access points belonging to the first subset for the terminal device TD1, and AP2 illustrates access points belonging to the second subset.

In the example illustrated in FIG. 7 it is assumed that the same transport block and format may be applied both to a unicast uplink (single connectivity) and to the connection oriented broadcast uplink (multi-connectivity). Another assumption made is that dedicated resources for the uplink are allocated to the terminal device. However, it should be appreciated that applying the implementation to a solution in which one or more dedicated resource pools are allocated to the terminal device, as will be described below with FIG. 8, is a straightforward procedure.

Referring to FIG. 7, in the exemplified implementation the multi-connectivity controller node MCN allocates in block 7-1 dedicated resources for the terminal device TD1 to send at least one scheduling assignment, and determines in block 7-1 necessary terminal device context, such as an identifier ID1 for the terminal device TD1. The identifier ID1 is a unique temporary identifier at the multi-connectivity controller node. The identifier ID1 may be used to identify the terminal device TD1, especially when terminal device identifier—based multiplexing is applied between the access points and the multi-connectivity controller node.

The multi-connectivity controller node MCN then indicates the terminal device context, i.e. terminal device-specific information, and the dedicated resource to the access points AP1 in the first subset (message 7-2) and to the access points AP2 in the second subset (message 7-2′). Message 7-2, 7-2′ will be sent via a network interface between the multi-connectivity controller node MCN and the access points AP1, AP2. Sending the terminal device-specific information to the access points simplifies and optimizes the monitoring, receiving and forwarding of transport blocks broadcast by the terminal device in the access points belonging to the cluster of the terminal device.

The multi-connectivity controller node MCN also informs (message 7-3) the terminal device TD1 on the allocated dedicated resource and the terminal device-specific information.

In the illustrated example, the second configuration sent to the access points in the second subset configures an access points to initially decide (block 7-5a) whether or not to take part in monitoring, and hence whether or not to detect, a scheduling assignment. The initial decision may be made using the same criteria as for deciding whether or not to take part in the receiving and forwarding. For example, the access point may decide not to monitor scheduling assignments if the scheduling assignment is to be sent in a preconfigured time slot or a sub-frame with other resource allocation for the access point. It should be appreciated that although the initial deciding is described with FIG. 7, it may be implemented with other examples as well. Further, the example of FIG. 7 may be implemented without such an initial decision.

The terminal device TD1 uses the dedicated resource to send a scheduling assignment (message 7-4) which should be detected by the access points AP1, AP2 monitoring the uplink. Upon receiving the scheduling assignment, an access point AP2 belonging to the second subset that has initially decided (block 7-5a) to monitor, and hence to detect the scheduling assignment, decides (block 7-5), as described above with FIG. 5, for example, whether or not to take part in receiving and forwarding the transport block for which the scheduling assignment was sent.

Then the terminal device TD1 adds (block 7-6) the unique identifier ID1 to the data packet and sends the transport block containing the data packet as the uplink broadcast (messages 7-7, illustrating one uplink broadcast).

Each access point AP1 in the first subset receives the transport block. If the data forwarding among access points belonging to the cluster of the terminal device are not synchronized in time for an individual received uplink packet of interest, and the format is either PHY TB or a MAC PDU, not MAC SDU, each access point AP1 in the first subset adds (block 7-8) an additional packet identifier ID2 to the transport block and after that forwards (message 7-7′) the transport block. The transport block (message 7-7′) contains the unique terminal device identifier ID1, the additional packet identifier ID2 and the data packet. The additional packet identifier may be a time stamp indicating the time the access point received the transport block, or the transmission time interval in which the transport block was received. Further, each access point in the second subset that has decided to take part to the receiving and forwarding the transport block performs the adding of the additional packet identifier before forwarding the transport block when there is no synchronization in time and the format is not MAC SDU. However, that is not illustrated in FIG. 7.

The time stamp, as well as the transmission time interval, is supposed to be the same across those access points that perform the receiving and forwarding.

The multi-connectivity controller node MNC uses the additional packet identifiers for packet duplicate handling (block 7-9). In other words, the additional packet identifiers are used for detecting and discarding duplicate packets in the multi-connectivity controller node MNC.

As said above, in the implementation the access points are configured not to add the additional packet identifier to the transport block if the data forwarding is strictly synchronized in time. However, in an alternative implementation the additional packet identifier may be added also when the data forwarding is synchronized in time.

In the implementation illustrated in FIG. 7, the additional packet identifier is not added to the transport block when the format used is MAC SDU. For the time being, it is assumed that radio link control (RLC) layer will perform the duplication detection and discarding duplicates of MAC SDUs received from different access points. However, in an alternative implementation the additional packet identifier may be added also when the format is MAC SDU.

In the example illustrated in FIG. 8 it is assumed that different transport block and format may be applied to a unicast uplink (single connectivity) and to the connection oriented broadcast uplink (multi-connectivity). Another assumption made is that a dedicated resource pool is allocated to the terminal device for the multi-connectivity. However, it should be appreciated that applying the implementation to a solution in which a dedicated resource allocated to the terminal device, as described above with FIG. 7, is a straightforward procedure. Further, parts of the exemplified information exchange in FIG. 8 are rather similar to that in described in FIG. 7, and hence they are not described in so detail.

Referring to FIG. 8, once the multi-connectivity controller node MCN has allocated in block 8-1 at least one dedicated resource pool for the terminal device TD1 to select a resource to send at least one scheduling assignment, and has determined in block 8-1 necessary terminal device context, such as the identifier ID1 for the terminal device TD1, to the multi-connectivity controller node MCN indicates the terminal device context, i.e. terminal device-specific information, and the allocated dedicated resource pool(s) to the access points AP1 in the first subset (message 8-2) and to the access points AP2 in the second subset (message 8-2′). The multi-connectivity controller node MCN also informs (message 8-3) the terminal device TD1 on the allocated dedicated resource pool(s) and the terminal device-specific information.

The terminal device TD1 then selects (block 8-4a) amongst available resources in the dedicated resource pool(s) a resource to send a scheduling assignment (message 8-4) which should be detected by the access points AP1, AP2 monitoring the uplink. Upon receiving the scheduling assignment, an access point AP2 belonging to the second subset decides (block 8-5)), as described above with FIG. 5, for example, whether or not to take part in receiving and forwarding the transport block for which the scheduling assignment was sent.

Then the terminal device TD1 adds (block 8-6) the unique terminal identifier ID1 to the data packet and an additional packet identifier, and sends the transport block containing the data packet and the two identifiers as the uplink broadcast (messages 8-7′, illustrating one uplink broadcast). The additional packet identifier may be a time stamp indicating the sending time of the transport block, or the time when the transport block was created, or the transmission time interval in which the transport block will be sent, or it may be a unique sequence number generated by the terminal device TD1.

Each access point AP1 in the first subset receives the transport block and forwards (message 8-7′) the transport block. Further, each access point in the second subset that has decided to take part to the receiving and forwarding the transport block performs the receiving and forwarding of the transport block, although it is not illustrated in FIG. 8.

The multi-connectivity controller node MNC uses the additional packet identifiers for packet duplicate handling (block 8-9).

In a still further implementation, based for example on implementation described above with FIG. 7 or 8, no additional packet identifier is used.

It should be appreciated that in the above examples blocks 7-1, 8-1, 9-1 may be part of determining the cluster and its other configuration, and messages 7-2, 8-2 may comprise also other configuration information for access points in the first subset, messages 7-2′, 8-2′ may comprise also other configuration information for access points in the second subset, and message 8-3 may comprise also other configuration information for the terminal device. Further, if the dedicated resource (resource pool) is reallocated and that is the only change, messages 7-2, 7-2′, 7-3, 8-2, 8-2′, and/or 8-3 may comprise only information on allocated resources.

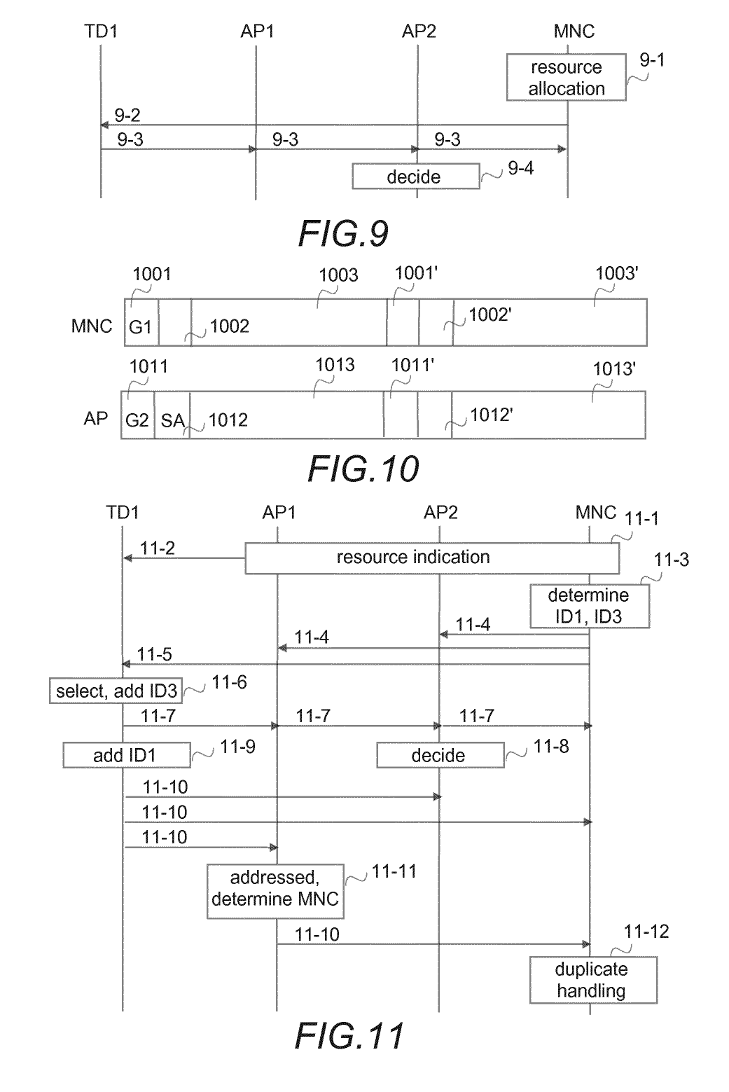

FIG. 9 illustrates information exchange in another exemplified implementation relating especially to scheduling information and its delivery. Unlike in the above examples, information exchange relating to determining, delivering and using the terminal device context is not illustrated. The information may have been sent earlier, for example.

Referring to FIG. 9, in the exemplified implementation the multi-connectivity controller node MCN allocates in block 9-1 dedicated resources for the terminal device TD1 to send at least one scheduling assignment and uplink transport block. Information on the allocated dedicated resource is sent (message 9-2) to the terminal device TD1. Unlike in the examples described with FIGS. 7 and 8, in the example of FIG. 9 the terminal device TD1 distributes the information on the allocated resources to the access points belonging to the cluster of the terminal device TD1 by transmitting the information in the scheduling assignment (message 9-3). Then the access point belonging to the second subset may use the information to decide (block 9-4)), as described above with FIG. 5 or below with FIG. 10, for example, whether or not to take part in the receiving and forwarding a transport block from the terminal device. From that on, the process may continue as described above, for example.

Using the implementation illustrated in FIG. 9 is particularly advantageous when the multi-connectivity controller node MCN belongs to the cluster of the terminal device TD1, and the dedicated resource allocation is highly dynamically.

In other words, the access points in the cluster may receive in advance information on uplink broadcast resources scheduled for the terminal device from the multi-connectivity controller node, or in scheduling assignments from the terminal device.

FIG. 10 illustrates an example of a physical frame structure that may be used in the implementation described above with FIG. 9 to provide multi-connectivity controller node —access point coordination when the scheduling assignment sent from the terminal device is used to distribute the information on allocated resources for the broadcast uplink resources.

Referring to FIG. 10, the basic parts of the frame structure include a downlink control part 1001, 1001′, 1011, 1011′, followed by an uplink control part 1002, 1002′, 1012, 1012′, that in turn is followed by a data part 1003, 1003′, 1013, 1013′. While other access points belonging to the cluster of the terminal device provide downlink control on downlink allocation in the downlink control part 1001 of current transmission time interval, the network node acting as the multi-connectivity controller node allocates dedicated resources to the terminal device for uplink broadcast-based transmission, and indicates in the downlink control part 1001 that uplink is granted (G1) for next transmission time interval data part 1003′. In other words, the control part is shifted from corresponding data part with one transmission time interval. Then the terminal device uses the uplink control part 1012 to send the scheduling assignment (SA) so that access points that belong to the cluster of the terminal device and are monitoring, receive the scheduling assignment. The terminal device sends in the downlink control part 1011 that downlink is granted (G2) for the same transmission time interval data part 1013.

Upon receiving the scheduling assignment first, the access points in the first subset are able to receive the uplink transmission in the next time interval data part 1013′ from the terminal device. Naturally, if for some reason an access point belonging to the first subset do not receive the scheduling assignment, it is not aware of the transport block, and hence will not receive and forward it.

Further, an access point belonging to the second subset may, based on the received scheduling assignments from different terminal devices in a previous transmission time interval, decide if the current transmission time interval is for downlink or uplink. For example, if an access point belonging to the second subset(s) does not receive any scheduling assignment, or receives one or more scheduling assignments with limited uplink resources may determine that the next transmission time interval can be used for downlink transmission instead of receiving uplink broadcast of the terminal device(s).

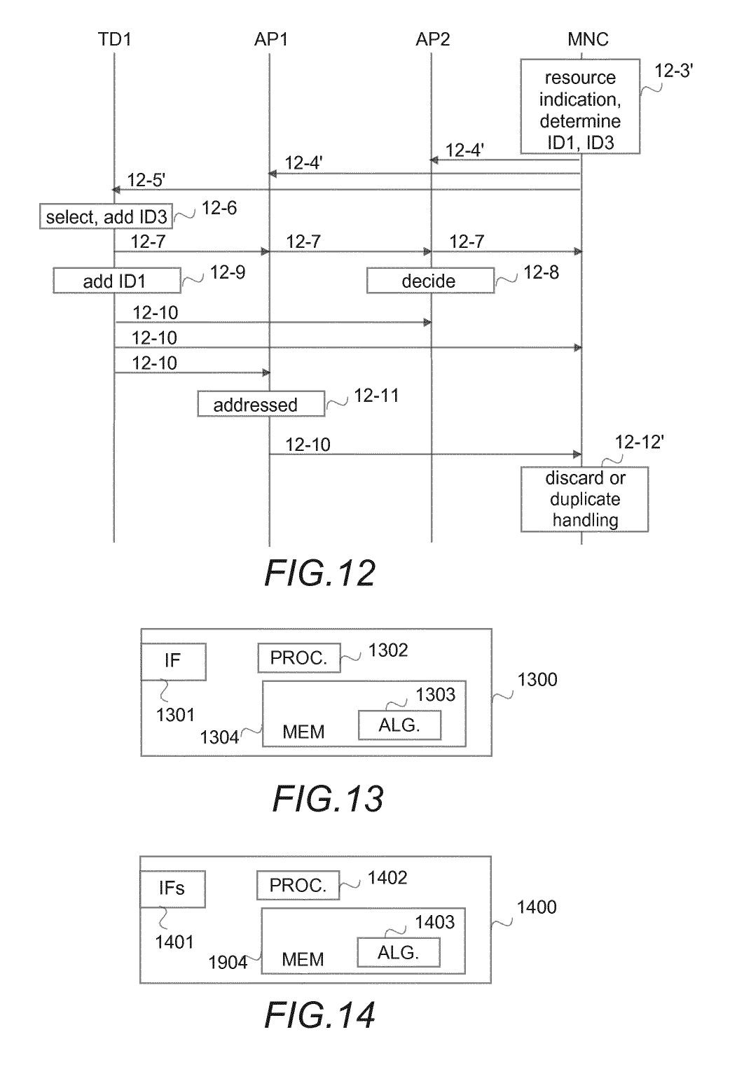

FIGS. 11 and 12 illustrate different exemplified implementation possibilities of the second mode in which the terminal device is configured, by the multi-connectivity controller node, to select or allocate resources from resource pools that are preconfigured for proximity broadcast based uplink transmissions. In the examples it is assumed that the cluster has been determined, and configurations for the first subset and for the second subset have been sent, AP1 illustrates access points belonging to the first subset for the terminal device TD1, and AP2 illustrates access points belonging to the second subset.

Referring to FIG. 11, in the illustrated example the current cluster of the terminal device is configured to indicate both the cluster and the terminal device for one or more preconfigured resource pools (block 11-1, message 11-2). However, it should be appreciated that the multi-connectivity controller node MCN may perform the indication to the access points in the cluster and to terminal device, as is described below with FIG. 12.

Further, in the illustrated example the multi-connectivity controller node MNC determines (block 11-3) the terminal device contexts for the terminal device TD1, such as the identifier ID1, and further a cluster identifier ID3 for the cluster of the terminal device TD1, the cluster identifier being unique within the multi-connectivity controller node. Once the identifiers are determined, the multi-connectivity controller node MNC configures (messages 11-4, 11-4′, 11-5) the identifiers to access points AP1, AP2 in the cluster and the terminal device TD1. After the configuration the terminal device may indicate ID3 in a scheduling assignment and the access point in the cluster may determine to receive only uplink packet transmissions addressed to it specifically by means of ID3 in a monitored and received scheduling assignment.

Since an access point may simultaneously be connected to and controlled by two or more different multi-connectivity controller nodes, there may be a collision on cluster identifier ID3 assignments from the different multi-connectivity controller nodes. The collision may be easily detected and resolved between involved access points and the multi-connectivity controller nodes. If the cluster identifier, coupled with any other cluster-specific configuration, such as the resource pool, is utilized for facilitating data forwarding, the collision may be detected and resolved beforehand. However, FIGS. 11 and 12 provide options, which, if used, do not require the collision detection and resolving beforehand.

Returning back to FIG. 11, the terminal device TD1 selects (block 11-6) amongst available resources in the preconfigured resource pool a resource to send a scheduling assignment (message 11-7) with the cluster identifier ID3 which scheduling assignment should be detected by the access points AP1, AP2 monitoring the uplink. Upon receiving the scheduling assignment, an access point AP2 belonging to the second subset decides (block 11-8) whether or not to take part in receiving and forwarding the transport block for which the scheduling assignment was sent.

Then the terminal device TD1 adds (block 11-9) the unique identifier ID1 to the data packet, and sends the transport block containing the identifier as the uplink broadcast (messages 11-10, illustrating one uplink broadcast).

Each access point AP1 in the first subset receives the transport block since the cluster has been addressed (block 11-11) in the scheduling assignment, and determines, using the terminal identifier ID1 and/or the cluster identifier ID3, the proper multi-connectivity controller node MNC and forwards (message 11-10) the transport block to the determined multi-connectivity controller node. Further, each access point in the second subset that has decided to take part to the receiving and forwarding the transport block performs the receiving, determining the multi-connectivity controller node and forwarding of the transport block, although it is not illustrated in FIG. 11.

The multi-connectivity controller node MNC performs packet duplicate handling (block 11-12) to packets received over the cluster.

FIG. 12 illustrates another exemplified implementation possibility. Parts of the exemplified information exchange in FIG. 12 are rather similar to that in described in FIG. 11, and hence they are not described in so detail.

Referring to FIG. 12, in the illustrated example the multi-connectivity controller node MCN is configured, in addition to determining (block 12-3′) the terminal device context for the terminal device TD1, including the identifier ID1, and the cluster identifier ID3, indicate (block 12-3′, messages 12-4′, 12-5′) one or more preconfigured resource pools of the terminal device and to configure (messages 12-4′, 12-5′) the identifiers ID1 and ID3 both to the access points in the cluster and to the terminal device. However, it should be appreciated that the current cluster of the terminal device may perform the indication to the access points in the cluster and to terminal device, as is described above with FIG. 11.

The terminal device TD1 selects (block 12-6) amongst available resources in the preconfigured resource pool a resource to send a scheduling assignment (message 12-7) with the cluster identifier ID3 which scheduling assignment should be detected by the access points AP1, AP2 monitoring the uplink. Upon receiving the scheduling assignment, an access point AP2 belonging to the second subset decides (block 12-8) whether or not to take part in receiving and forwarding the transport block for which the scheduling assignment was sent.

Then the terminal device TD1 adds (block 12-9) the unique identifier ID1 to the data packet, and sends the transport block containing the identifier as the uplink broadcast (messages 12-10, illustrating one uplink broadcast).

Each access point AP1 in the first subset receives the transport block since the cluster has been addressed (block 12-11) in the scheduling assignment, and forwards (message 12-10) the transport block to each multi-connectivity controller node who has assigned the same cluster identifier. Hence, the forwarding may be interpreted to be a blind forwarding. Further, each access point in the second subset that has decided to take part to the receiving and forwarding the transport block performs the receiving and blind forwarding of the transport block, although it is not illustrated in FIG. 12.

The multi-connectivity controller node MNC uses detailed control information in the packet header of the received packet, for example to determine whether the packet is meant to be received by the multi-connectivity controller node MNC or not. If the packet is not meant to the multi-connectivity controller node MNC, it discards (block 12-12′) the packet. If the packet is meant to the multi-connectivity controller node, it performs packet duplicate handling (block 12-12′) to packets received over the cluster.

Although not described above, in the illustrated examples of FIGS. 11 and 12, the additional packet identifier ID2 may be used, as described above with FIGS. 7 and 8, in addition to ID1 and ID3, to facilitate duplicate handling.

In other solutions, no ID1 (or no ID2) are added in the example of FIG. 12.

In other implementations, either an access point or the terminal device is configured to add to the packet sent in the transport block a destination address that may be used in addition to, or instead of, the cluster identifier ID3 and/or the unique terminal device identifier ID1. The destination address may be the address of the multi-connectivity controller node, or the address of a multi-connectivity anchor.

To summon up, the above use of broadcast radio connection may actually use less radio resources and have a lower control overhead compared to a use of multiple unicast radio connections. The use of the connection-oriented uplink broadcast allows the terminal device to transmit uplink transmissions to one or more access points simultaneously, and since the multi-connectivity is realized on physical medium access control layer level, there is no need to set up and maintain radio connection with many access points. The latency of uplink transmissions is reduced notably, because the terminal device is authorized to schedule its uplink transmission towards all relevant access points simultaneously by using the scheduling assignment. As is evident from the above examples, the use of the second subset further increases the probability that the transport block is received correctly be the serving network at the very first attempt, and therefore the reliability is increased as well as latency of uplink transmissions from the terminal device is reduced. Hence a solution providing ultra-high reliability and ultra-low latency may be achieved by the disclosed multi-connectivity scheme.

As to implementing the above for introducing the single-frequency-network based multi-transmitter diversity multi-connectivity scheme for the downlink direction, a cluster for the downlink direction may be determined using the above principles applied to the downlink direction, and then access points in the cluster are divided to belong either to a first subset taking part to the downlink data receiving and forwarding and to a second subset in which an access point may decide, applying the above principles, for example, whether or not to take part to the downlink data receiving and forwarding. The first subset, or at least one serving access point in the first subset may be configured to schedule downlink resource allocation and transmit downlink transmission for the terminal device. The other access point in the cluster, especially those in the second subset, may use similar decision criteria as described above to decide whether or not to take part in transmitting the scheduled downlink transmission to the terminal device using otherwise the single-frequency-network transmission. An example of the decision criteria is using a probability of P or Poffset, where P, and possible Q, described above, may be explicitly configured and controlled by the multi-connectivity control node or the multi-connectivity anchor or determined by individual access point, or being partly determined by t the multi-connectivity control node or the multi-connectivity anchor and partly by the individual access point.

Depending on an implementation, the clusters with subsets may be determined separately for the uplink and for the downlink, depending on service requirements for uplink and downlink, or the cluster with separate subsets, or the cluster and the subsets may be determined to be the same for the uplink and the downlink.

The blocks, related functions, and information exchanges described above by means of FIGS. 2 to 12 are in no absolute chronological order, and some of them may be performed simultaneously or in an order differing from the given one. Other functions can also be executed between them or within them, and other information may be sent. For example, the reconfiguring of a cluster and its subsets, as well as scheduling, are continuous control operations during the period the terminal device is served in the multi-connectivity mode, although not explicitly repeated in the above. Further, also the access points in the cluster are reconfigured in response to the multi-connectivity mode ending, or the access point not any more belonging to the cluster. Another example includes determining the targeted multi-connectivity anchor node. The targeted multi-connectivity anchor node may be determined by a forwarding access point in the cluster based on terminal device-specific control information preconfigured to the access points in the cluster of the terminal device using a network signaling procedure, or data packet-specific control information, such as a destination address included in a header of a received uplink medium access control layer protocol data unit (MAC PDU) from the terminal device. Further, the forwarding access point may be configured to provide necessary labeling to the received packet for it to be forwarded to the targeted multi-connectivity anchor, depending on or adapted to which level, for example PHY TB, MAC PDU, or MAC SDU, the received transport block (the data packet) is forwarded. Some of the blocks or part of the blocks or one or more pieces of information can also be left out or replaced by a corresponding block or part of the block or one or more pieces of information.

The techniques and methods described herein may be implemented by various means so that an apparatus/network node/terminal device configured to support at least multi-connectivity scheme that is at least partly based on what is disclosed above with any of FIGS. 1 to 12, including implementing one or more functions/operations of a corresponding network node/terminal device described above with an embodiment/example, for example by means of any of FIGS. 2 to 12, comprises not only prior art means, but also means for implementing the one or more functions/operations of a corresponding functionality described with an embodiment, for example by means of any of FIGS. 2 to 12, and it may comprise separate means for each separate function/operation, or means may be configured to perform two or more functions/operations. For example, one or more of the means and/or the terminal device-specific configuration unit and/or the decision unit and/or the multi-connectivity unit for one or more functions/operations described above may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, logic gates, other electronic units designed to perform the functions described herein by means of FIGS. 1 to 12, or a combination thereof. For firmware or software, the implementation can be carried out through modules of at least one chipset (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

FIGS. 13 and 14 provide apparatuses according to some embodiments of the invention. FIG. 13 illustrates an apparatus configured to carry out the functions described above in connection with a base station. FIG. 14 illustrates an apparatus configured to carry out the functions described above in connection with the terminal device. Each apparatus may comprise one or more communication control circuitry, such as at least one processor 1302, 1402, and at least one memory 1304, 1404 including one or more algorithms 1303, 1403, such as a computer program code (software) wherein the at least one memory and the computer program code (software) are configured, with the at least one processor, to cause the respective apparatus to carry out any one of the exemplified functionalities of each respective apparatus.

The memories 1304, 1404 may be implemented using any suitable data storage technology, such as semiconductor based memory devices, flash memory, magnetic memory devices and systems, optical memory devices and systems, fixed memory and removable memory. The memory may comprise a configuration database for storing configuration data for the connection-oriented multi-connectivity, as described above, for example with FIG. 1.

The apparatuses may further comprise different interfaces 1301, 1401, such as a communication interface (TX/RX) comprising hardware and/or software for realizing communication connectivity according to one or more communication protocols. The communication interface may provide the apparatus with communication capabilities to communicate in the cellular communication system and enable communication between different network nodes and between the terminal device and the different network nodes, for example. The communication interface may comprise standard well-known components such as an amplifier, filter, frequency-converter, (de)modulator, and encoder/decoder circuitries and one or more antennas. The communication interfaces may comprise radio interface components providing the network node and the terminal device with radio communication capability in the cell. Further, the terminal device 1400 may comprise one or more user interfaces, such as a screen, microphone and one or more loudspeakers for interaction with the user.

In an embodiment of FIG. 13, at least some of the functionalities of the network node 1300 may be shared between two physically separate devices, forming one operational entity. Therefore, the apparatus may be seen to depict the operational entity comprising one or more physically separate devices for executing at least some of the described processes. Thus, the apparatus of FIG. 13, utilizing such a shared architecture, may comprise a remote control unit (RCU), such as a host computer or a server computer, operatively coupled (e.g. via a wireless or wired network) to a remote radio head (RRH) located in a base station site. In an embodiment, at least some of the described processes of the network node may be performed by the RCU. In an embodiment, the execution of at least some of the described processes may be shared among RRH and RCU. In such a context, RCU may comprise the components illustrated in FIG. 13, and the communication interface may provide RCU with the connection to RRH. RRH may then comprise radio frequency signal processing circuitries and antennas, for example.

In an embodiment, RCU may generate a virtual network through which RCU communicates with RRH. In general, virtual networking may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer (i.e. to RCU). External network virtualization is targeted to optimized network sharing. Another category is internal virtual networking which provides network-like functionality to the software containers on a single system. Virtual networking may also be used for testing the terminal device.

In an embodiment, the virtual network may provide flexible distribution of operations between RRH and RCU. In practice, any digital signal processing task may be performed in either RRH or RCU and the boundary where the responsibility is shifted between RRH and RCU may be selected according to implementation.

Referring to FIG. 13, at least one of the communication control circuitries in the apparatus 1300 is configured to provide the terminal device-specific configuration unit and/or the decision unit, or any sub-unit, and to carry out functionalities described above by means of any of FIGS. 2 to 5 and 7 to 12 by one or more circuitries.

Referring to FIG. 14, at least one of the communication control circuitries in the apparatus 1400 is configured to provide or the multi-connectivity unit, or any corresponding sub-unit, and to carry out functionalities described above by means of any of FIGS. 6 to 12 by one or more circuitries.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In an embodiment, the at least one processor, the memory, and the computer program code form processing means or comprises one or more computer program code portions for carrying out one or more operations according to any one of the embodiments of FIGS. 2 to 12 or operations thereof.

Embodiments as described may also be carried out in the form of a computer process defined by a computer program or portions thereof. Embodiments of the methods described in connection with FIGS. 2 to 12 may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Even though the invention has been described above with reference to examples according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A method comprising:
determining, in a multi-connectivity control node of a terminal device, an access point cluster for the terminal device, the access point cluster comprising two or more access points for multi-connectivity;
determining, in the multi-connectivity control node, which ones of the two or more access points in the access point cluster belong to a first subset of the access point cluster and which ones to a second subset of the access point cluster, the first subset comprising at least one access point and the second subset comprising at least one access point;
causing sending a first configuration to the at least one access point in the first subset, the first configuration configuring an access point to receive and forward one or more scheduled transport blocks from the terminal device and/or to the terminal device; and
causing sending a second configuration to the at least one access point in the second subset, the second configuration configuring an access point to decide whether or not to receive and forward one or more scheduled transport blocks from the terminal device and/or to the terminal device and to treat the one or more scheduled transport blocks accordingly.

2. The method as claimed in claim 1, wherein the determining, in a multi-connectivity control node of a terminal device, an access point cluster is performed based on at least one of neighboring cell information of an access point serving the terminal device in single-connectivity and one or more reports relating to the terminal device, a report being received from the terminal device or from an access point in a proximity of the terminal device.

3. The method as claimed in claim 1, wherein the access point cluster is determined for uplink broadcast transmissions from the terminal device.

4. The method as claimed in claim 1, wherein the access point cluster is determined for downlink multi-connectivity transmissions to the terminal device.

5. The method as claimed in claim 1, wherein the determining of the access point cluster, the first subset and the second subset, the causing sending of the first configuration and the causing sending of the second configuration is repeated in response to receiving one or more reports relating to the terminal device.

6. The method as claimed in claim 1, further comprising:
allocating, by the multi-connectivity control node, one or more dedicated resources for transmission of one or more transport blocks and/or for transmitting a scheduling assignment from the terminal device; and
causing distributing information on the dedicated resources to the terminal device and to the access points in the access point cluster.

7. The method as claimed in claim 1, further comprising:
determining, by the multi-connectivity control node, a cluster identifier for the access point cluster; and
causing distributing the cluster identifier to the access points in the access point cluster and to the terminal device.

8. A method comprising:
receiving, in an access point, a configuration for a terminal device;
detecting, in the access point, a scheduling assignment for a transport block from the terminal device or to terminal device;
in response to the configuration for the terminal device being a first configuration causing the access point to receive and forward one or more scheduled transport blocks from and/or to the terminal device, causing receiving and forwarding the scheduled one or more transport blocks; and
in response to the configuration for the terminal device being a second configuration causing the access point to decide whether or not to receive and forward one or more scheduled transport blocks from and/or to the terminal device, performing deciding and treating the scheduled one or more transport blocks accordingly.

9. The method as claimed in claim 8, further comprising:
receiving in the access point a new configuration for the terminal device;
updating the configuration in use correspondingly.

10. The method as claimed in claim 8, wherein the configuration is for uplink broadcast transmissions from the terminal device.

11. The method as claimed in claim 8, further comprising:
adding, in the access point, before causing forwarding the transport block, to the transport block an additional packet identifier.

12. The method as claimed in claim 11, wherein the additional packet identifier is a time the transport block was received or a transmission time interval of the transport block.

13. The method as claimed in claim 11, further comprising performing the adding in response to the access point not being synchronized in time with other access points in an access point cluster of the terminal device, the access point cluster comprising two or more access points for multi-connectivity, and/or in response to the format used for the transport block being either a physical layer transport block or a medium access control layer packed data unit.

14. The method as claimed in claim 8, further comprising:
receiving in the access point a cluster identifier as part of the configuration information; detecting the scheduling assignment in response to the scheduling assignment comprising the cluster identifier.

15. The method as claimed in claim 8, further comprising:
receiving in the access point a cluster identifier and a temporary terminal identifier of the terminal device as part of the configuration information;
detecting the scheduling assignment in response to the scheduling assignment comprising the cluster identifier;
receiving a scheduled uplink transport block;
determining a multi-connectivity anchor node of the terminal device by using at least one of the temporary terminal identifier in the transport block and the cluster identifier; and
causing sending the transport block towards the multi-connectivity anchor.

16. A method comprising:
detecting in a terminal device an indication indicating a use of an access point cluster for multi-connectivity;
receiving in the terminal device a configuration for the multi-connectivity, the configuration indicating at least one access point in the access point cluster;
receiving in the terminal device an indication of a preconfigured resource or a dedicated resource allocated, the resource being at least for a scheduling assignment for a broadcast uplink transport block;
causing sending the scheduling assignment; and
causing sending one or more transport blocks according to a schedule in the scheduling assignment.

17. The method as claimed in claim 16, further comprising:
receiving, by the terminal device, in the configuration information on whether to use a physical layer transport block, a medium access control layer protocol data unit or a medium access control layer service data unit for the transport block; and
causing sending by the terminal device the transport block accordingly.

18. The method as claimed in claim 16, further comprising:
causing distribution of the information on the resource to access points belonging to an access point cluster providing the multi-connectivity by sending a scheduling assignment from the terminal device.

19. The method as claimed in claim 16, further comprising:
adding, by the terminal device, to a transport block before causing sending the transport block an additional packet identifier that is the sending time of the transport block or a transmission time interval of the transport block or a sequence number of the transport block.

20. The method as claimed in claim 16, further comprising:
receiving in the terminal device, as part of the configuration information, a cluster identifier of the access point cluster; and
adding, before sending the scheduling assignment, the cluster identifier to the scheduling assignment.

21. An apparatus comprising:
at least one processor, and
at least one memory comprising a computer program code, wherein the processor, the memory, and the computer program code are configured to cause the apparatus to:
determine an access point cluster for a terminal device, the access point cluster comprising two or more access points for multi-connectivity;
determine which ones of the two or more access points in the access point cluster belong to a first subset of the access point cluster and which ones to a second subset of the access point cluster, the first subset comprising at least one access point and the second subset comprising at least one access point;
cause sending a first configuration to the at least one access point in the first subset, the first configuration configuring an access point to receive and forward one or more scheduled transport blocks from the terminal device and/or to the terminal device; and
cause sending a second configuration to the at least one access point in the second subset, the second configuration configuring an access point to decide whether or not to receive and forward one or more scheduled transport blocks from the terminal device and/or to the terminal device and to treat the one or more scheduled transport blocks accordingly.

22. The apparatus as claimed in claim 21, wherein the processor,
the memory, and the computer program code are further configured to cause the apparatus to repeat, in response to receiving one or more reports relating to the terminal device, the determining of the access point cluster, the first subset and the second subset, the causing sending of the first configuration and the causing sending of the second configuration.

23. An apparatus comprising:
at least one processor, and
at least one memory comprising a computer program code, wherein the processor, the memory, and the computer program code are configured to cause the apparatus to use a received multi-connectivity configuration for a terminal device, the use causing the apparatus to:
detect a scheduling assignment for a transport block from the terminal device or to terminal device;
receive and forward, in response to the configuration for the terminal device being a first configuration causing the apparatus to receive and forward one or more scheduled transport blocks from and/or to the terminal device, the scheduled one or more transport blocks; and
decide, in response to the configuration for the terminal device being a second configuration causing the apparatus to decide whether or not to receive and forward one or more scheduled transport blocks from and/or to the terminal device, whether or not to receive and forward the scheduled one or more transport blocks, and treat the scheduled one or more transport blocks accordingly.

24. The apparatus as claimed in claim 21, wherein the access point cluster is determined for uplink broadcast transmissions from the terminal device.

25. A terminal device comprising:
at least one processor, and
at least one memory comprising a computer program code, wherein the processor, the memory, and the computer program code are configured to cause the apparatus to:
detect an indication indicating a use of an access point cluster for multi-connectivity;
receive a configuration for the multi-connectivity, the configuration indicating at least one access point in the access point cluster;
receive an indication of a preconfigured resource or a dedicated resource allocated, the resource being at least for a scheduling assignment for a broadcast uplink transport block;
cause sending the scheduling assignment; and
cause sending one or more transport blocks according to a schedule in the scheduling assignment.

26. The terminal device as claimed in claim 25, wherein the processor, the memory, and the computer program code are further configured to cause the apparatus to:
receive in the configuration information on whether to use a physical layer transport block, a medium access control layer protocol data unit or a medium access control layer service data unit for the transport block; and
cause sending the transport block accordingly.

27. The terminal device as claimed in claim 25, wherein the processor, the memory, and the computer program code are further configured to cause the apparatus to distribute the information on the dedicated resource to access points belonging to an access point cluster providing the multi-connectivity by sending the information in a scheduling assignment.

28-31. (canceled)
